(19) United States
(12) Patent Application Publication
(10) Pub. No.: US 2019/0072162 A1
(43) Pub. Date: Mar. 7, 2019

(54) BALL SCREW MECHANISM

(71) Applicant: Schaeffler Technologies AG & Co. KG, Herzogenaurach (DE)

(72) Inventors: Markus Oswald, Erlangen (DE); Stefan Michaloudis, Nürnberg (DE); Mario Kreutzer, Sonneberg (DE)

(73) Assignee: Schaeffler Technologies AG & Co. KG, Herzogenaurach (DE)

(21) Appl. No.: 15/765,517

(22) PCT Filed: Oct. 19, 2016
(86) PCT No.: PCT/DE2016/200475

§ 371 Date: Apr. 3, 2018

(30) Foreign Application Priority Data
Oct. 21, 2015 (DE) 10 2015 220 515.0

(51) Int. Cl. F16H 25/20; F16H 25/22; F16D 23/12

(52) U.S. Cl. CPC F16H 25/2015; F16H 25/2223; F16D 2125/40; F16H 25/2209; F16D 2023/123; F16D 23/12

(57) ABSTRACT

Ball screws are disclosed, such as a ball screw having a spindle nut which is arranged on a threaded spindle and in which balls are received which roll along ball tracks of the spindle nut and the threaded spindle, and having a first stop element associated with the spindle nut and a second stop element associated with the threaded spindle, wherein at least one stop element has a resiliently deformable body.

### CROSS-REFERENCE TO RELATED APPLICATIONS

This application is the U.S. National Phase of PCT Appln. No. PCT/DE2016/200475 filed Oct. 19, 2016, which claims priority to DE 102015220515.0 filed Oct. 21, 2015, the entire disclosures of which are incorporated by reference herein.

### TECHNICAL FIELD

The disclosure relates to a ball screw having a spindle nut which is arranged on a threaded spindle and in which balls are received which roll along ball tracks of the spindle nut and the threaded spindle, and having a first stop element associated with the spindle nut and a second stop element associated with the threaded spindle.

### BACKGROUND

DE 10 2008 025 349 A1 discloses a ball screw which has stop parts of which one is arranged on a deflection piece arranged on the spindle nut and another is arranged on the threaded spindle. In a ball screw, either the spindle nut or the threaded spindle is driven. If the threaded spindle is driven, the spindle nut is moved axially upon a rotation of the threaded spindle. Conversely, if the spindle nut is driven, the threaded spindle is moved axially upon a rotation of the spindle nut. The ball screw described in the said publication is designed such that the two stop parts strike against one another when an end position is reached, whereby the relative movement is delimited.

A further ball screw having a stop element is disclosed in DE 10 2008 062 180 A1. Incorporated in the end face of the spindle nut is a groove which is delimited circumferentially by a stop face. If the spindle nut and the threaded spindle are twisted relative to one another, the spindle-side circumferential stop and the nut-side circumferential stop approach one another in one of the two directions of rotation until mutually facing stop faces of the two stops finally strike against one another and prevent a further relative rotation. The spindle nut is therefore prevented from jamming.

In a conventional ball screw of this type, a perceptible noise is produced when the two stop elements contact one another, although this noise is undesirable in certain applications.

### SUMMARY

Therefore, an object of the disclosure is to provide a ball screw which causes no noise or only a damped stop noise.

To achieve this object, it is provided according to the disclosure that at least one stop element has a resiliently deformable body.

The disclosure is based on the recognition that soundless or at least low-noise operation of a ball screw is possible if a resiliently deformable body is associated with at least one stop element. Upon contact between the two stop elements, a resilient deformation takes place whereby a stop noise is prevented or damped to the extent that it is tolerable.

The ball screw according to the disclosure is advantageous in that the resiliently deformable body can be manufactured economically and can moreover be realized without affecting the installation space.

According to a first embodiment of the disclosure, the spindle nut can be surrounded by a sleeve on which the stop element associated with the spindle nut is integrally formed.

According to a second, alternative embodiment of the disclosure, the stop element associated with the spindle nut can be arranged on a deflection body for the balls.

In one advantageous manner, in the ball screw according to the disclosure, it can be provided that the resiliently deformable body is manufactured from a plastic material or from an elastomer material. The resiliently deformable body can be fixedly connected to the stop element, for example the resiliently deformable body can be vulcanized thereon. However, it can also be held with force fit or form fit; for example, it can be clamped, bonded or screwed on.

The resiliently deformable body of the ball screw according to the disclosure can be arranged either on the spindle nut or on the threaded spindle. In both cases, the resiliently deformable body is associated with the stop element, that is to say it is preferably mounted on the stop element such that the other stop element abuts against the resiliently deformable body when the end position is reached.

A variant of the stop element of the ball screw according to the disclosure provides that the stop element has a rigid component which is surrounded by the resiliently deformable body. The rigid component can be designed for example as a pin or the like, which is surrounded by an annular resilient deformable body. Alternatively, the rigid component can also be designed as a bolt or screw which is surrounded by the resiliently deformable body. The rigid components and the resiliently deformable body can be fixedly connected to one another, for example the rigid component can be extrusion-coated with an elastomer material or the elastomer material can be vulcanized onto the rigid component.

It is also within the scope of the disclosure that that stop element which does not have a resiliently deformable body is movable against a rigid face forming a stop. In this embodiment, this can be a face of the ball screw nut, a face of the sleeve or a face of a deflection body for deflecting the balls.

A further alternative embodiment of the ball screw according to the disclosure provides that the resiliently deformable body is mounted on a deflection body for the balls. The deflection body therefore serves as a stop element and, with the respective other stop element, forms a delimitation for the relative movement between the spindle nut and the threaded spindle.

The ball screw according to the disclosure can be a component of a parking brake for a motor vehicle. In addition, it can also be used in a so-called e-booster and generally in an electromechanical brake or a clutch actuator for a motor vehicle.

### BRIEF DESCRIPTION OF THE DRAWINGS

The disclosure is explained below with the aid of embodiments with reference to the drawings. The drawings are schematic illustrations and show:

FIG. 1 shows a first embodiment of a ball screw according to the disclosure in a perspective view;

FIG. 2 shows a second embodiment of a ball screw according to the disclosure;

FIG. 3 shows a further embodiment of a ball screw according to the disclosure;

FIG. 4 shows the ball screw shown in FIG. 3, wherein the spindle nut is only partially illustrated;

FIG. 5 shows a further embodiment of a ball screw according to the disclosure in a partially sectional side view;

FIG. 6 shows a view of the ball screw of FIG. 5 in the axial direction;

FIG. 7 shows a perspective view of the ball screw of FIG. 5;

FIG. 8 shows the ball screw of FIG. 5 in the released state in a partially sectional side view;

FIG. 9 shows the ball screw of FIG. 8 in an axial view;

FIG. 10 shows a further embodiment of a ball screw according to the disclosure in a perspective view;

FIG. 11 shows an enlarged illustration of the stop elements of the ball screw of FIG. 10;

FIG. 12 shows the ball screw shown in FIGS. 10 and 11 after the contact between the stop elements;

FIG. 13 shows an axial view of the ball screw of FIG. 12 when the end position is reached;

FIG. 14 shows the moment of impact of the stop element;

FIG. 15 shows the ball screw of FIG. 10 after complete deformation;

FIGS. 16-18 shows details of a further embodiment of a ball screw nut; and

FIGS. 19-21 shows details of a further embodiment of a ball screw nut.

### DETAILED DESCRIPTION

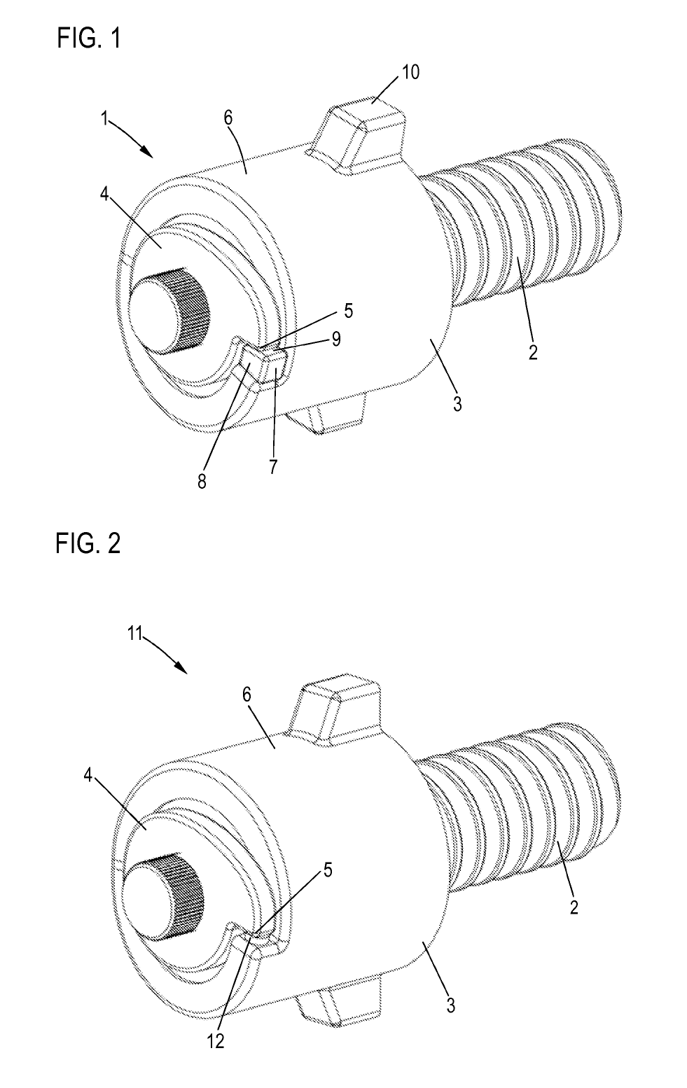

FIG. 1 is a perspective view and shows a ball screw 1 having a threaded spindle 2 and a spindle nut 3. In a manner known per se, balls (not shown) roll along ball tracks of the threaded spindle 2 and the spindle nut 3. In a known manner, the spindle nut 3 has one or more deflection pieces (not shown), wherein a deflection piece connects a start and an end of a common winding of a ball channel to one another in a continuous manner. The balls are thus moved in a continuous revolution upon a relative movement between the threaded spindle 2 and the spindle nut 3. The threaded spindle 2 is connected in a torque-proof manner to a stop plate 4 which has a stop element 5 designed as a stop face. On its outside, the spindle nut 3 has a sleeve 6 which is pressed onto the spindle nut 3. The sleeve 6 is accordingly connected to the spindle nut 3 with force fit and form fit. The sleeve 6 can therefore transmit a torque to the spindle nut 3. The sleeve 6, which is manufactured from thin-walled sheet metal in a forming procedure, is provided with a stop element 7 which has a resiliently deformable body 8. The resiliently deformable body 8 is cuboidal in design and is made from an elastomer material. The body 8 has a stop face 9 which lies against the corresponding face of the stop plate 4 when the two stop elements 5, 7 contact one another.

The sleeve 6 is provided with protrusions 10 which are integrally formed thereon in one piece and are arranged distributed over the circumference. The protrusions 10 serve as twist prevention for the spindle nut 3. The protrusions 10 can engage for example in grooves of a component (not shown), for example of a housing or a piston, so that the spindle nut 3 is prevented from twisting relative to this component.

If the stop element 5 associated with the threaded spindle 2 and the stop element 7, that is to say the resiliently deformable body 8, associated with the spindle nut 3 strike against one another when the end position is reached, the impact energy is at least partially converted into deformation energy of the resiliently deformable body 8. Accordingly, noise production is prevented so that the ball screw 1 can be operated noiselessly or at least with extremely low noise.

FIG. 2 shows a second embodiment of a ball screw 11 which is designed in substantially the same manner as the ball screw 1 shown in FIG. 1. Repeated detailed explanation of corresponding components is therefore dispensed with at this point.

Corresponding to the first embodiment, the ball screw 11 has the stop plate 4, which is connected in a torque-proof manner to the threaded spindle 2 and has the stop element 5. The sleeve 6 connected to the spindle nut 3 has a stop element 12 which is designed as a plate-shaped resiliently deformable body. The resiliently deformable body is likewise manufactured from an elastomer material and serves as a circumferential stop when the spindle nut 3 and the threaded spindle 2 reach their end position.

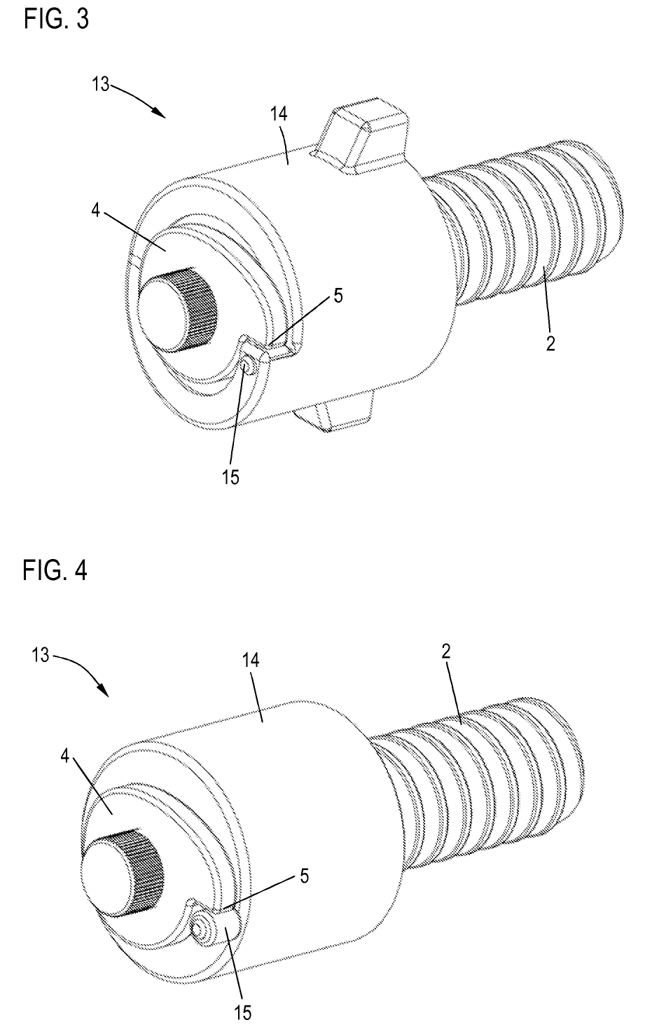

FIGS. 3 and 4 show a further embodiment of a ball screw 13, wherein FIG. 3 is a perspective view and, in FIG. 4, the sleeve and the spindle nut are only partially illustrated. A stop element having a resiliently deformable body 15 is arranged on the sleeve 14, which is designed in one piece with the spindle nut. The body 15 is cylindrical in design; its longitudinal axis is arranged parallel to the longitudinal axis of the threaded spindle 2. Corresponding to the first embodiments, the stop plate 4 has the stop element 5, which is designed as a face and, in the end position, lies against the stop element which is associated with the spindle nut and the sleeve 14 and is designed as the body 15. The resiliently deformable body prevents stop noise being produced when the end position is reached and serves simultaneously as twist prevention for the sleeve 14 relative to the threaded spindle 2.

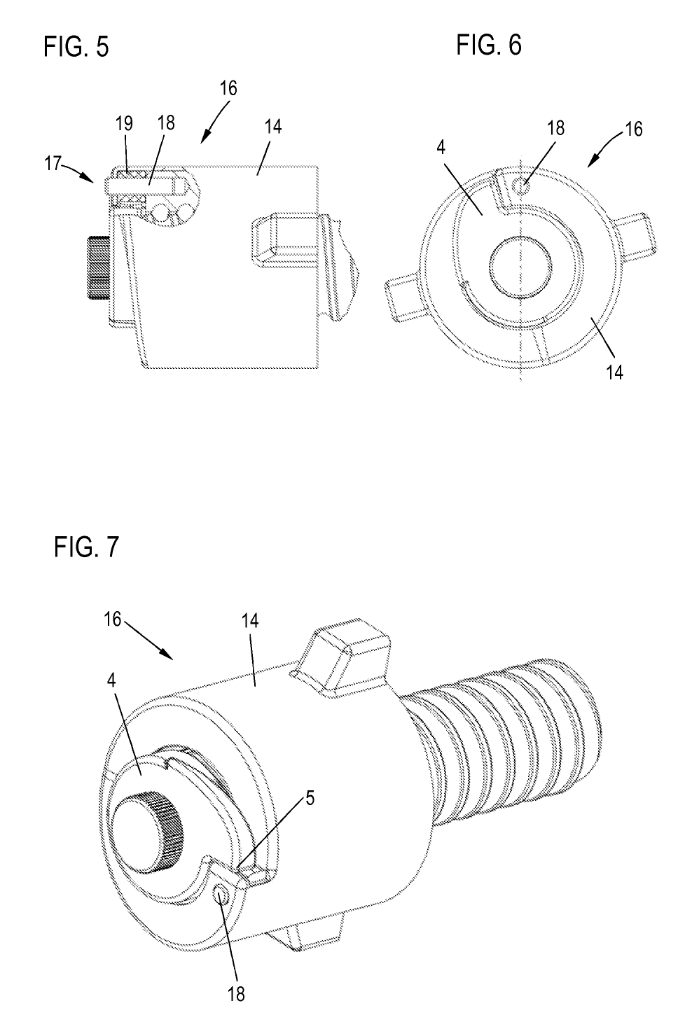

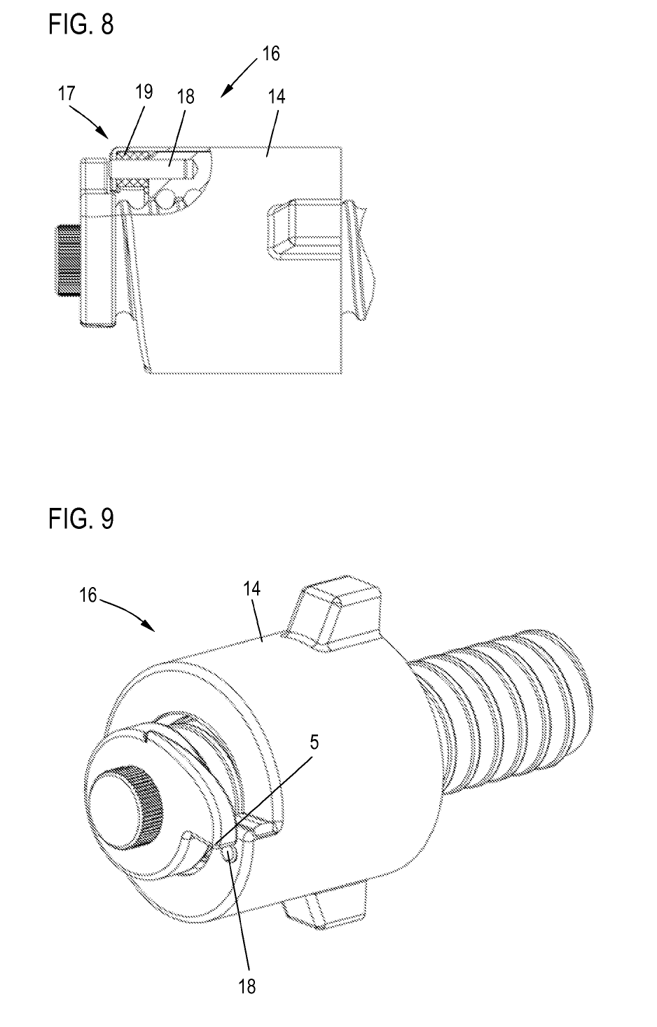

FIGS. 5, 6 and 7 show a further embodiment of a ball screw 16, which is constructed in a similar manner to the ball screw 13 shown in FIGS. 3 and 4. FIG. 5 is a partially sectional side view, FIG. 6 is a view in the axial direction and FIG. 7 is a perspective view of the ball screw 16. A stop element 17 arranged on the sleeve 14 comprises a rigid component 18 which is designed as a pin and is fixedly connected to the sleeve 14. The rigid component 18 is surrounded by the resiliently deformable body 19, which forms a stop for the face of the stop element 5 of the stop plate 4. FIGS. 8 and 9 likewise show a ball screw 16, but in the released state, that is to say when it is not located in the end position. FIG. 8 corresponds here to FIG. 5 and shows the ball screw 16 in a partially sectional side view, FIG. 9 corresponds to FIG. 7 and shows the ball screw 16 in a perspective view.

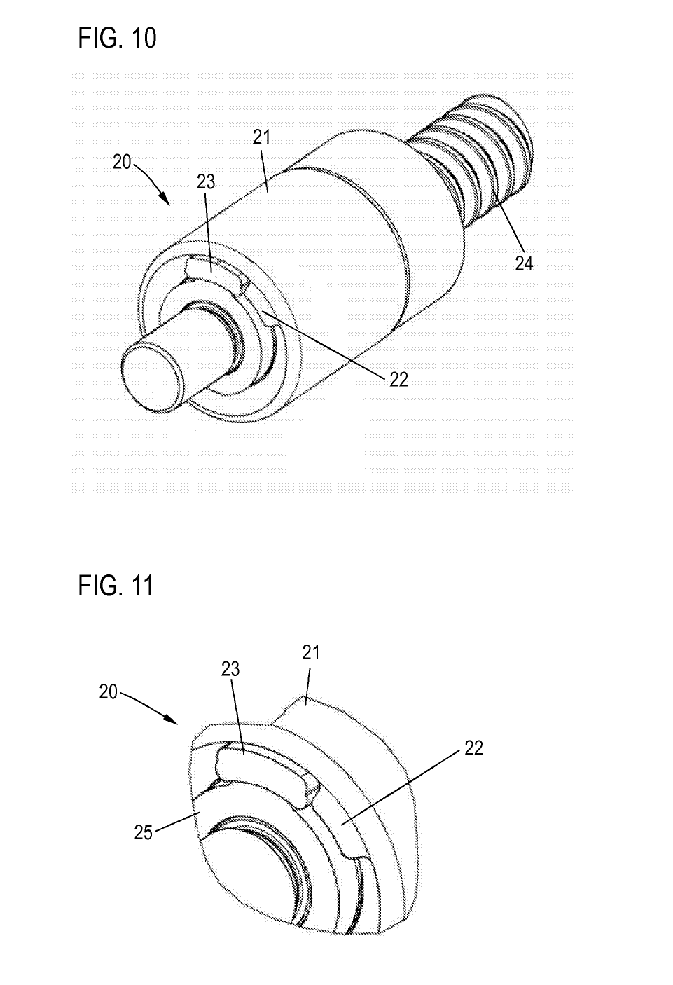

FIG. 10 shows a further embodiment of a ball screw 20 in a perspective view, FIG. 11 is an enlarged illustration of the stop elements of the ball screw 20. The ball screw 20 comprises a spindle nut 21 which is provided with a sleeve and has a rigid stop element 22. The stop element 22 is designed in one piece with the sleeve or the spindle nut 21 and is located radially inside on an axial end. A further stop element 23 is associated with the threaded spindle 24. The stop element 23 is designed as a resiliently deformable body. FIGS. 10 and 11 show the ball screw 20 in the situation when the rotating threaded spindle 24 contacts the stop element 22 associated with the spindle nut 21 by its stop element 23 designed as a resiliently deformable body. The resiliently deformable body damps the impact, whereby the production of impact noise is prevented.

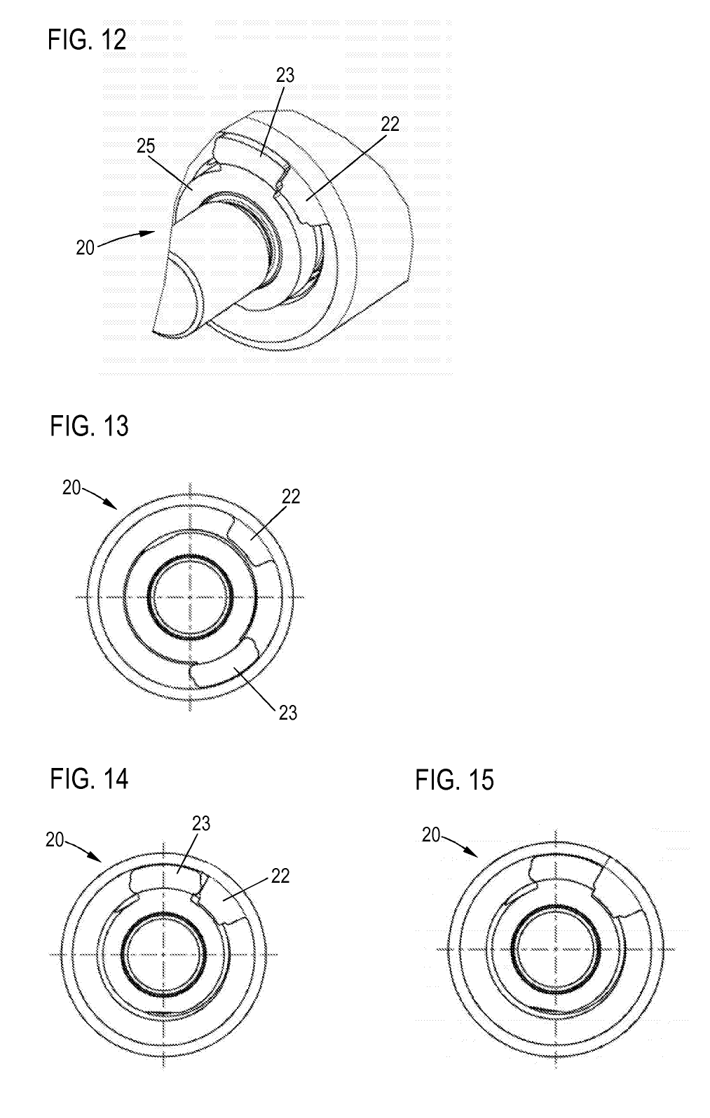

FIG. 12 is a similar view to FIGS. 10 and 11 and shows the ball screw 20 after the contact between the two stop elements 22, 23. After the damping capacity of the stop element 23 designed as a resiliently deformable body has been exhausted, the stop plate 25, on which the stop element 23 designed as a resiliently deformable body is arranged, moves into an end position via the rigid stop element 22, whereby the end stop is reached.

FIGS. 13, 14 and 15 shows the end position being reached in an axial view in each case. In FIG. 13, the stop element 23 having the resiliently deformable body is located in a position remote from the rigid stop element 22. FIG. 14 shows the moment of impact of the stop element 23 against the stop element 22. It can be seen from FIG. 14 that the stop element 23 designed as a resiliently deformable body is outwardly curved on the contact side. This curvature enables a deformation of the resiliently deformable body upon striking against the stop element 22. This curvature forms a damping region, the deformation of which results in the absorption of impact energy. FIG. 15 shows the ball screw 20 after the resiliently deformable body has been completely deformed. The stop element 22 and the stop element 23 are in full-face contact with one another here.

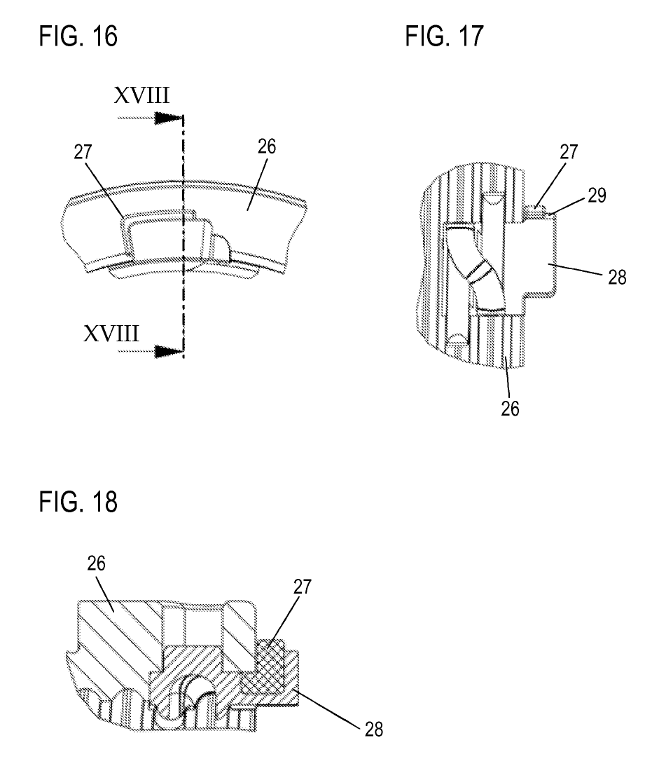

FIGS. 16, 17 and 18 show details of a further embodiment of a spindle nut 26, wherein FIG. 16 is a plan view, FIG. 17 is a sectional view and FIG. 18 is a sectional view along the line XVIII-XVIII of FIG. 16. In contrast to the previous embodiments, the spindle nut does not have a sleeve. The spindle nut 26—as can be seen in FIG. 17—has a deflection body 28 for balls on which a rigid stop element 29 designed as a face is designed with a resiliently deformable body 27.

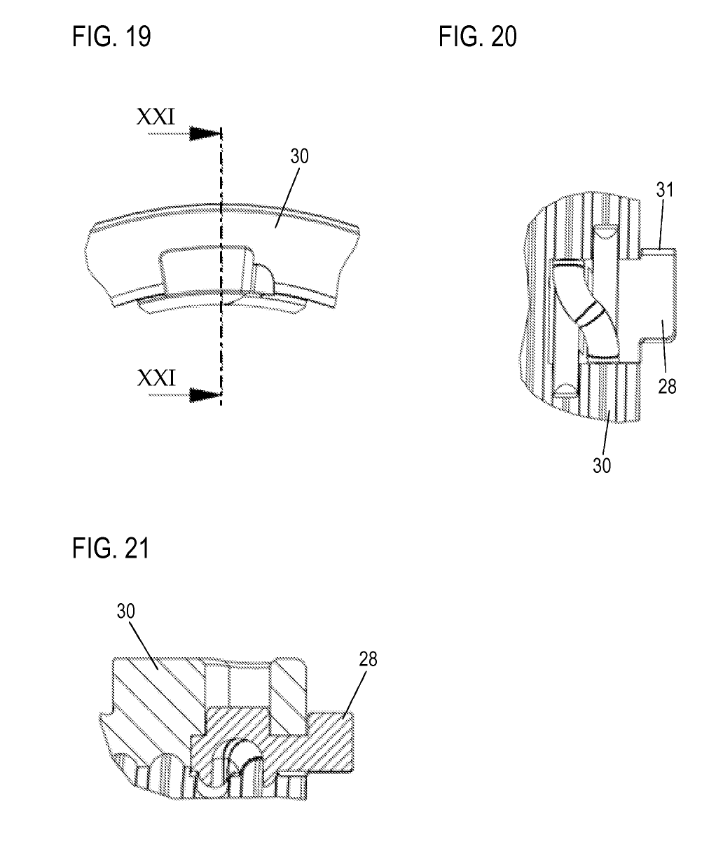

FIGS. 19, 20 and 21 show details of a further embodiment of a spindle nut 30 which does not have a sleeve, wherein FIG. 19 is a plan view. FIG. 20 is a sectional view and FIG. 21 is a sectional view along the line XXI-XXI of FIG. 19. Corresponding to the previous embodiment, the spindle nut 30 has the deflection body 28 on which a stop element 31, which is designed as an end stop and has a resiliently deformable body, is arranged.

The ball screws shown in the different embodiments may be components of an electric parking brake for a motor vehicle.

### LIST OF REFERENCE SIGNS

Ball screw

Threaded spindle

Spindle nut

Stop plate

Stop element

Sleeve

Stop element

Body

Stop face

Protrusions

Ball screw

Stop element

Ball screw

Sleeve

Body

Ball screw

Stop element

Rigid component

Body

Ball screw

Threaded nut

Rigid stop element

Stop element

Threaded spindle

Stop plate

Spindle nut

Body

Deflection body

Stop element

Spindle nut

Stop element
1-8. (canceled)

9. A ball screw comprising:
a threaded spindle;
a spindle nut arranged on the threaded spindle and in which balls are received which roll along ball tracks of the spindle nut and the threaded spindle; and
a first stop element associated with the spindle nut and a second stop element associated with the threaded spindle;
wherein the spindle nut is surrounded by a sleeve on which the stop element associated with the spindle nut is integrally formed, which stop element has a resiliently deformable body arranged on the spindle nut.

10. The ball screw as claimed in claim 9, wherein the stop element associated with the spindle nut is arranged on a deflection body for the balls.

11. The ball screw as claimed in claim 9, wherein the resiliently deformable body is manufactured from a plastic material or an elastomer material.

12. The ball screw as claimed in claim 9, wherein the stop element has a rigid component which is surrounded by the resiliently deformable body.

13. The ball screw as claimed in claim 9, wherein the stop element associated with the threaded spindle is movable against a rigid face forming a stop or an end stop.

14. The ball screw as claimed in claim 9, wherein it is a component of a parking brake for a motor vehicle, an e-booster, an electromechanical brake or a clutch actuator.
